(19) United States
(12) Patent Application Publication
(10) Pub. No.: US 2008/0143070 A1
(43) Pub. Date: Jun. 19, 2008

(54) Shopping Trolley Comprising Wheels

(76) Inventors: Horst Sonnendorfer, Puchheim (DE); Franz Wieth, Puchheim (DE)

Correspondence Address: LERNER GREENBERG STEMER LLP, P O BOX 2480, HOLLYWOOD, FL, 33022-2480, US

(21) Appl. No.: 11/815,533

(22) PCT Filed: Jan. 26, 2006
(86) PCT No.: PCT/DE06/00121

§ 371 Date: Aug. 3, 2007

(30) Foreign Application Priority Data
Feb. 3, 2005 (DE) DE202005001777.9

(51) Int. Cl. B60B 33/00

(52) U.S. Cl. 280/86

(57) ABSTRACT

A wheel for a supermarket trolley, includes an immobilizer which is connected to the trolley by way of a simple carrier limb having a shaft fixed thereto. The rim of the wheel is embodied in such a way that, when the wheel is mounted on the trolley, the battery, running surface and other parts can be replaced via an opening that can be closed by a cover.

### TECHNICAL FIELD

The invention relates to shopping trolleys comprising wheels.

### PRIOR ART

What are referred to as immobilizers are known for shopping trolleys. As well as mechanically triggered immobilizers, immobilizers which are triggered electronically and have an electronic system and a battery in the rim of the wheel are also known.

In the known immobilizers, the battery has to be replaced at certain intervals. To do this it is necessary to dismount the wheels from the shopping trolley, open the wheels, replace the battery and then mount everything again.

The known design of such an immobilizer is composed of a fork limb through which the carrying shaft of the wheel runs.

This known design makes changing the battery disadvantageously complex because in order to change the wheel it is necessary to remove the carrying shaft from the fork limbs before the wheel can be changed.

If an immobilizer is activated and as a result the wheel can no longer rotate, partial abrasion of the tread on the wheel occurs if the customer nevertheless attempts to move the trolley. In order to renew the tread of the wheel it is disadvantageously necessary to dismount the wheel with known immobilizers.

DE 4431277 C2 has disclosed a bearing system for a wheel of a shopping trolley which is composed of a single supporting limb with a shaft attached to it. In this design, the effort required to dismount the wheel is reduced but it is still complicated. This document does not contain any indication that the wheel presented there is a wheel of an immobilizer and that with this wheel it is possible to change a battery or a tread.

### DISCLOSURE OF THE INVENTION

### Technical problem

The problem of the invention is to provide a device in which the battery, the tread or other parts in an immobilizer can be changed quickly and more easily than in the known immobilizers and the known wheels, in particular without having to dismount the wheel from the shaft.

### Technical solution

According to the invention this problem is solved by using, instead of the forked limb, a single supporting limb with a shaft attached thereto and by embodying the rim of the wheel in such a way that it has a cover on the side facing away from the supporting limb, and after the removal of the cover the battery, the tread or other parts of the immobilizer can be replaced.

### ADVANTAGEOUS EFFECTS

It is thus possible, for example with a wheel which is mounted on a shopping trolley, to change the batteries, the tread or other parts from the free side.

The battery, the tread or other parts can thus be advantageously replaced in a relatively short time.

The effort involved in changing the battery, the tread or other parts is advantageously reduced.

### EMBODIMENT OR EMBODIMENTS OF THE INVENTION

The invention is explained in more detail with reference to a FIGURE.

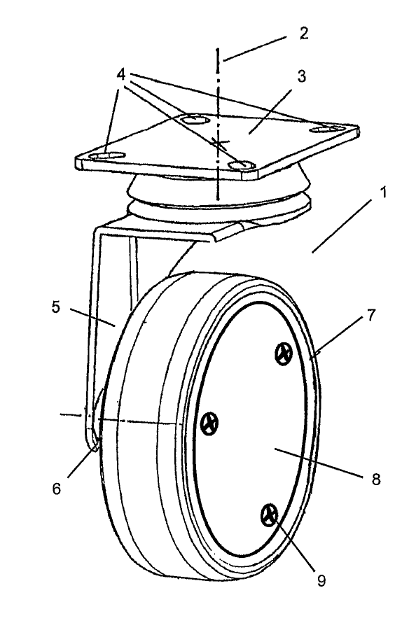

FIG. 1 is a perspective illustration of a steerable wheel 1 which can be steered about an axis 2. The base plate 3 can be attached by means of a plurality of attachment points 4 to a shopping trolley (not shown here). A single-sided limb 5 is attached to the base plate 3 so as to be rotatable about the axis 2. A shaft 6, of which only a part can be seen, protrudes laterally from the limb 5.

The wheel 7 is attached to the shaft 6 using attachment means (not shown in more detail) after said wheel 7 has been completely fitted onto the shaft 6.

This prevents the wheel 7 being able to move axially and thus becoming undesirably released again from the shaft 6.

The side of the wheel 7 which faces away from the limb 5 is covered by a cover 8. The cover 8 can be removed after the screws 9 have been released.

The screws 9 are preferably screws which cannot be released with a generally available screwdriver. They are preferably what are referred to as security screws which can only be released with a screwdriver of special design which is not widely available.

Under the cover 8 there is, inter alia, a battery which is necessary for operating the immobilizer and is regularly replaced.

The tread and the rim are embodied in such a way that the tread can be pulled off the rim in the axial direction. A new tread is fitted onto the rim in the axial direction. The torque which is produced during rolling is transmitted from the tread to the rim by a positive engagement between the rim and the tread which are matched to one another.

The battery, the tread and/or other parts within the wheel 7 of the immobilizer of a wheel can thus be changed very quickly and easily.

The described principle can also be applied in wheels which cannot be steered.

### INDUSTRIAL APPLICABILITY

The invention can be applied wherever it is necessary to change a battery and/or some other component of a worn or non-round wheel quickly. This is usually the case when a shopping trolley is repaired, for example.

1-3. (canceled)

4. A shopping trolley comprising wheels,
wherein the wheels are each mounted so as to be rotatable about a shaft, the shaft is attached by one of its ends to a carrier element, and the wheel can be fitted onto the other, still free end of the shaft and can be secured to the shaft in an axially non-displaceable fashion, characterized in that the wheel has, on its side facing away from the carrier element, an opening which permits access to parts of the immobilizer and which can be closed off by a cover.

5. The shopping trolley comprising wheels as claimed in claim 4, characterized in that the rim of the wheel is embodied in such a way that the tread can be pulled off the rim in the axial direction when the cover is removed.

6. The shopping trolley comprising wheels as claimed in claim 4, characterized in that the tread can be pulled off the rim of a wheel which is mounted on the shopping trolley and can be fitted onto the rim.
